(19) United States
(12) Patent Application Publication
(10) Pub. No.: US 2011/0264770 A1
(43) Pub. Date: Oct. 27, 2011

(54) APPARATUS AND METHOD FOR COOPERATIVELY OPERATING WEB BROWSER AND LOCAL RESOURCE IN MOBILE TERMINAL

(75) Inventors: Seung-Hyun KIM, Daejeon (KR); Dae Seon Choi, Daejeon (KR); Soo Hyung Kim, Daejeon (KR); Jong-Hyouk Noh, Daejeon (KR); Sang Rae Cho, Daejeon (KR); Young Seob Cho, Daejeon (KR); Seunk Hun Jin, Daejeon (KR)

(73) Assignee: Electronics and Telecommunications Research Institute, Daejeon (KR)

(21) Appl. No.: 13/091,767

(22) Filed: Apr. 21, 2011

(30) Foreign Application Priority Data
Apr. 22, 2010 (KR) 10-2010-0037538

(51) Int. Cl. G06F 15/16

(52) U.S. Cl. 709/219

(57) ABSTRACT

An apparatus for cooperatively operating a Web browser and a local resource in a mobile terminal includes a Web browser for receiving a Web page requesting a local resource from a Web server connected to the mobile terminal; and a gateway server for controlling the local resource with parameters of the Web page and transmitting information regarding execution results of the local resource to the Web server by way of the Web browser. The parameters of the Web page include at least one of an ID of the Web server, a callback address (CallbackURL), a requested local resource function, and signature information.

### CROSS-REFERENCE(S) TO RELATED APPLICATION

The present invention claims priority of Korean Patent Application No. 10-2010-0037538, filed on Apr. 22, 2010, which is incorporated herein by reference.

### FIELD OF THE INVENTION

The present invention relates to a technique for cooperatively operating a Web browser and a local resource in a mobile terminal and, more particularly, to an apparatus and method cooperatively operating a Web browser and a local resource by using a local gateway server which operates independently from an operating system Web browser in a mobile terminal such as a smartphone.

### BACKGROUND OF THE INVENTION

In general, a scheme allowing a Web browser and a local resource to interwork is limited in a mobile terminal environment including a smartphone.

Thus, a first method for allowing the Web browser and the local resource to interwork is utilizing a plug-in function of the Web browser. The function of accessing the local resource by using a plug-in scheme supported for each browser may be developed. In this method, however, although the function of accessing a local resource for a Web browser supporting the plug-in scheme can be easily developed, but it needs to be developed separately for each operating system. In addition, such an interworking scheme is unavailable for a Web browser which does not support the plug-in scheme. Particularly, the Web browser equipped in a mobile terminal is mostly limited in its function, so it is difficult to apply the plug-in scheme thereto.

A second method is developing a dedicated Web browser. The dedicated Web browser recognizes a particular keyword/tag and performs a particular function by utilizing a local resource. However, this method also has a problem in that it must be developed separately for each operating system and an existing web browser cannot execute the corresponding function, thus degrading wide use.

### SUMMARY OF THE INVENTION

Therefore, the present invention provides an apparatus and method for cooperatively operating a Web browser and a local resource by using a local gateway server that independently operates from an operating system or Web browser in a mobile terminal.

Further, the present invention provides a method for allowing a Web browser to access and control a local resource, for the local resource or a local application, which does not have a communication function and cannot interwork with the Web browser, through a locally driven gateway server.

In accordance with an aspect of the present invention, there is an apparatus for cooperatively operating a Web browser and a local resource in a mobile terminal, the apparatus including: a Web browser for receiving a Web page requesting a local resource from a Web server connected to the mobile terminal; and a gateway server for controlling the local resource with parameters of the Web page and transmitting information regarding execution results of the local resource to the Web server by way of the Web browser.

In accordance with another aspect of the present invention, there is provided a method for cooperatively operating a Web browser and a local resource in a mobile terminal, the method including: controlling a local resource with parameters received from a Web server by way of the Web browser in the mobile terminal; and transmitting information regarding execution results of the local resource to the Web server by way of the Web browser.

In accordance with still another aspect of the present invention, there is provided a method for cooperatively operating a Web browser and a local resource in a mobile terminal, the method including: requesting, at the mobile terminal, a Web server for a particular service and receiving a Web page requesting a local resource; delivering, at the Web browser, the Web page to a gateway server and allowing the gateway server to parse and verity parameters of the Web page; controlling the local resource based on content of the parsed and verified parameters; setting local resource control result as a response parameter and delivering the set response parameter to the Web browser; and transmitting, at the Web browser a result page including the response parameter to the Web server.

### BRIEF DESCRIPTION OF THE DRAWINGS

The objects and features of the present invention will become apparent from the following description of embodiments, given in conjunction with the accompanying drawings, in which:

FIG. 1 is a block diagram showing a configuration of a mobile terminal that accesses a Web server in accordance with an embodiment of the present invention;

FIG. 2 is a flowchart illustrating an operational procedure of a mobile terminal and a Web server in accordance with the embodiment of the present invention; and

FIG. 3 is a flowchart illustrating an operational procedure of a gateway server within a mobile terminal in accordance with the embodiment of the present invention.

### DETAILED DESCRIPTION OF THE EMBODIMENTS

Hereinafter, an embodiment of the present invention will be described in detail with the accompanying drawings.

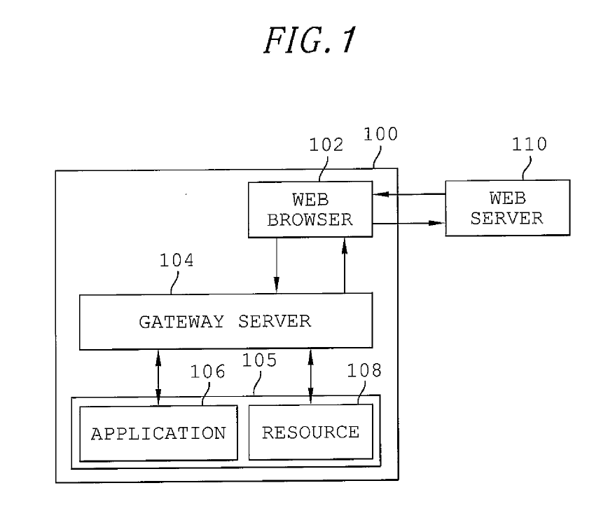

FIG. 1 is a block diagram showing a configuration of a mobile terminal that accesses a Web server in accordance with an embodiment of the present invention.

Referring to FIG. 1, a mobile terminal 100 is connected to a Web server 110 which provides an Internet service through a mobile communication network. The mobile terminal 100 includes a Web browser 102, a gateway 104, an application 106, a resource 108 and the like.

Specifically, the Web browser 102 is a program basically equipped to be driven in the mobile terminal 100, and it is driven when a user wants to receive a Web service. When the Web browser 102 is driven, the Web browser 102 requests the Web server 110 for a particular service. Then, the Web server 110 provides the requested service by using a hypertext transfer protocol (HTTP) channel or a hypertext transfer protocol over secure socket layer (HTTPS) channel.

In addition, the Web browser 102 delivers parameters including at least one of an ID (e.g. CallbackURL) of the Web server 110, a requested local resource function, and signature information to the gateway server 104. Then, the gateway server 104 verifies the received parameters and executes a particular function. The execution results may be delivered to the CallbackURL of the Web server 110 in an HTTP redirect manner.

The gateway server 104 accesses the Web server 110 through the Web browser 102 driven in the mobile terminal 100. Further, the gateway server 104 can access and control a particular local resource 105 upon being called by the Web browser 102 in a Form Post/Redirect manner.

That is, the gateway server 104 can control the local resource 105 with the parameters received from the Web server 110 by way of the Web browser 102 and transmit a result message to the Web server 110 by way of the Web browser 102.

Since the gateway server 104 operates in the Form Post/Redirect manner, it can operate independently from the operating system and the Web browser 102 in the mobile terminal 100.

Here, the local resource 105 includes the application 106 and the resource 108. Further, the local resource 105 includes every resource that can be processed in the mobile terminal 100. The application 106, a program to be driven in the mobile terminal, includes a case that can hardly communicate with the exterior of the terminal (e.g., HTTP). The resource 108 includes data files such as a directory, a music file, or a document.

The application 106 and the resource 108 have restrictions in that they are not allowed to be accessed directly through the Web browser 102 to be used for a Web service. The Web server 110 provides a Web service through the Web browser 102 within the user's mobile terminal 100 as connected, and may request interworking with the application 106 and the resource 108 provided in the mobile terminal 100.

Now, a process in which the Web server 110 interworks with the Web browser 102 and the local resource 105 by using the gateway server 104 of the mobile terminal 100 in accordance with the embodiment of the present invention will be described in more detail with reference to the accompanying drawings.

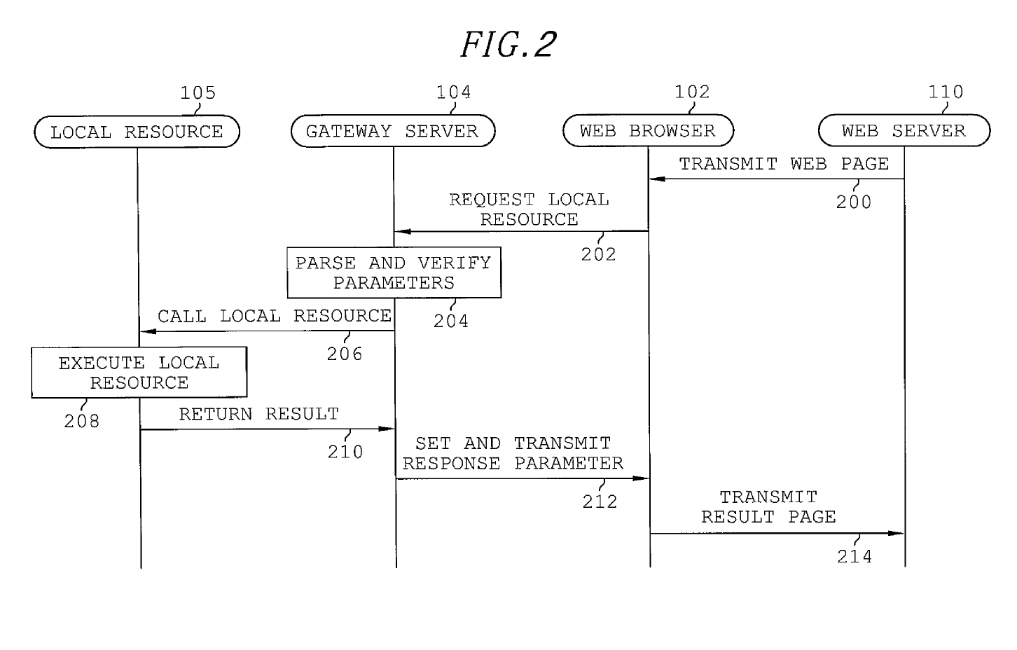

FIG. 2 is a flowchart illustrating an operational procedure of a mobile terminal and a Web server in accordance with the embodiment of the present invention.

Referring to FIG. 2, when the mobile terminal 100 requests the Web server 110 for a particular service, the Web server 110 delivers a Web page that requires a particular resource or operation of the mobile terminal 100 to the Web browser 102 within the mobile terminal 100 in step 200. The Web page is expressed in a format which can be basically processed by the Web browser 102, and the Web browser 102 may transfer a particular parameter requesting a local resource to the gateway server 104 by using the format in step 202.

Table 1 below shows an example of a source code of the Web page.

TABLE 1

<form method=post action=http://localhost:8080>

<input type=hidden name=requester-id value=‘ etri.re.kr’>
<input type=hidden name=callbackurl value=‘

/smw/callback.jsp’>

<input type=hidden name=operation value=‘ run application’>
<input type=hidden name=target value=‘ cert’ >
<input type=hidden name=parameter value=‘

operation=sign&value=xxx’>

<input type=hidden name=signature value=‘ yyyy’>

</form>

Regarding the Web page source code in Table 1, the content nested inside <form> is transferred to a gateway server having an address ‘http://localhost:8080’ as specified in an action item. The localhost refers to a loopback address, which ensures that the content nested inside the form tag is transmitted to the gateway server 104 being driven in the mobile terminal 100, on which the Web page is loaded. <input> includes parameters delivered to the gateway server 104. That is, ‘requester-id’ indicates the identity of the Web server 1100 calling the gateway server 104 and ‘callbackurl’ specifies a reception position of a response message. ‘Operation’ indicates a function to be executed by the gateway server 104, ‘target’ indicates a local resource name, and ‘parameter’ indicates a parameter required to call a local application. Further, ‘signature’ indicates the signature of a caller of an entire content. A corresponding parameter may be described not only in html but also in various formats, such as xml that can be used in the Web browser 102.

As such, after the Web browser 102 receives a corresponding Web page from the Web server 110, it performs a function of calling the gateway server 104 as in step 202. In this case, the user may explicitly select a ‘submit’ button described inside <form> (herein, the button is not exemplified inside <form>), or an automatic calling scheme utilizing javascript or the like may be used.

The gateway server 104 parses the parameters specified inside the <form>, and verifies the content of the parameters by using the value of the signature field in step 204. Thereafter, the gateway server 104 calls the local resource 105 as specified in the parameters of, e.g., the ‘operation’, ‘target’ and the like in Table 1, in step 206.

The local resource 105 including the application 106 and the resource 108 is changed or executed in response to the call from the gateway server 104 in step 208. Specifically, in case of the resource 108, particular content of the resource 108 may be generated, read, updated and deleted depending on the content specified in the parameters. In case of the application 106, a particular application is called and executed depending on the content specified in the parameters. Result information output through execution of the local resource 105 is transferred to the gateway server 104 in step 210. The gateway server 104 collects the transferred result information, sets a response parameter in step 212, and transfers the response parameter to callbackurl which is the parameter received in step 202 by way of Web browser 102. Table 2 shows an example of a message received at the Web browser 102.

TABLE 2
HTTP/1.1 302 Moved Temporarily
Server: Apache-Coyote/1.1
Set-Cookie: JSESSIONID=83EA9F79CB3A76E3FE7F98A8338FADEE;
Path=/
Location:
http://etri.re.kr/smw/callback.jsp?status=success&response=xxxx&si
gnature=yyyy
Content-Type: text/html
Content-Length: 0
Date: Wed, 07 Apr 2010 06:24:19 GMT

As for the example, the callbackurl, as a service end point of the Web server 110, and the response parameter can be checked in a Location item. Since the message corresponds to 302 redirect as the HTTP Redirect method, the result page generated by the Web browser 102 is automatically moved to the callbackurl in step 214. In this case, the format of the message received by the Web server 200 is shown in Table 3 below.

TABLE 3
GET smw/callback.jsp?status=success&response=xxxx&signature=yyyy
HTTP/1.1
Accept:
Accept-Language: ko
Accept-Encoding: gzip, deflate
User-Agent:
Connection: Keep-Alive
Host: etri.re.kr

As for the example in Table 3, the service end point of the Web server 110 and the response parameter can be checked in a GET request. Also, it can be checked that the address of the Web server 110 is “etri.re.kr” in a Host item. After verifying the response parameter, the Web server 110 may provide a particular service based on the content.

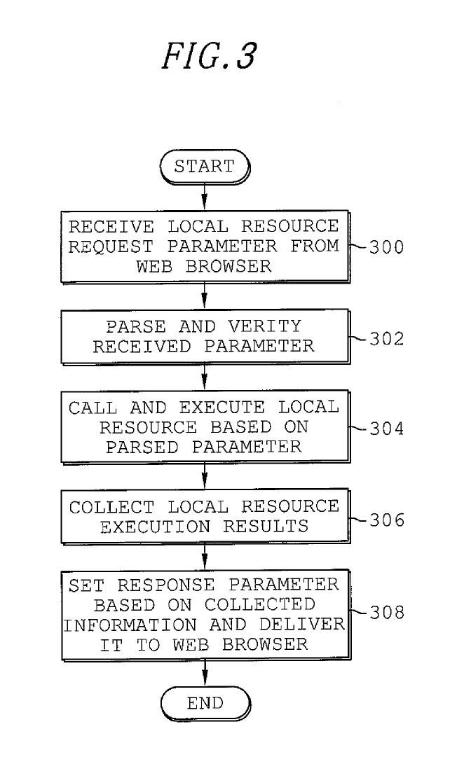

FIG. 3 is a flowchart illustrating an operational procedure of a gateway server within a mobile terminal in accordance with the embodiment of the present invention.

With reference to FIG. 3, the gateway server 104 receives a parameter requesting a local resource from the Web browser 102 in step 300, parses the received parameter, and then verifies the content of the parameter by using the value of a signature field indicating the signature of a caller in step 302.

When the verification is completed, the gateway server 104 calls and executes the local resource 105 in accordance with an execution function specified in the parameters of, e.g., ‘parameter’, ‘operation’ and ‘target’ in table 1 in step 304.

Thereafter, the gateway server 104 receives execution result information of the called local resource 105, collects the received execution result information in step 306, and sets a response parameter based on the collected information and transfers the set response parameter to the Web browser 102 in step 308.

As described above, in the apparatus and method for cooperatively operating the Web browser and the local resource in the mobile terminal in accordance with the embodiment of the present invention, for the local application or resource which does not have a communication function and cannot interwork with the Web browser, the Web browser can access and control the local resource through the locally driven gateway server.

In addition, since the local gateway server is used, the Web browser and the local resource can interwork without a separate plug-in in the mobile terminal. Moreover, since the local gateway server operates by using the HTTP Redirect scheme, it can be utilized independently from the operating system or Web browser.

Further, the existing technique fails to enable the mobile terminal to use a digital certificate using a Web browser or provide a payment/settlement service, while the present invention can provide a stable, convenient service by cooperatively operating the dedicated module (resource) mounted in the mobile terminal and the Web browser.

While the invention has been shown and described with respect to the particular embodiments, it will be understood by those skilled in the art that various changes and modification may be made without departing from the scope of the invention as defined in the following claims.

What is claimed is:

1. An apparatus for cooperatively operating a Web browser and a local resource in a mobile terminal, the apparatus comprising:
a Web browser for receiving a Web page requesting a local resource from a Web server connected to the mobile terminal; and
a gateway server for controlling the local resource with parameters of the Web page and transmitting information regarding execution results of the local resource to the Web server by way of the Web browser.

2. The apparatus of claim 1, wherein the parameters of the Web page include at least one of an ID of the Web server, a callback address (CallbackURL), a requested local resource function, and signature information.

3. The apparatus of claim 1, wherein the gateway server parses the parameters of the Web page and checks a signature field value to verify content of the parameters.

4. The apparatus of claim 3, wherein the gateway server performs one or more of generating, reading, updating and deleting a data file of the local resource based on the content of the parameters.

5. The apparatus of claim 3, wherein the gateway server calls a particular application of the local resource based on the content of the parameters to execute it and receives corresponding execution results.

6. The apparatus of claim 1, wherein the gateway server sets the information regarding execution results as a parameter and delivers the set parameter as a response parameter to the parameters of the Web page including the callback address to the Web browser.

7. A method for cooperatively operating a Web browser and a local resource in a mobile terminal, the method comprising:
controlling a local resource with parameters received from a Web server by way of the Web browser in the mobile terminal; and
transmitting information regarding execution results of the local resource to the Web server by way of the Web browser.

8. The method of claim 7, wherein said controlling a local resource includes:
parsing the received parameters; and
checking a signature field value of the parsed parameters to verify content of the parameters.

9. The method of claim 7, wherein said controlling a local resource performs one or more of generating, reading, updating and deleting a data file of the local resource based on the content of the parameters.

10. The method of claim 7, wherein said controlling a local resource calls a particular application of the local resource based on the content of the parameters to execute it and receives corresponding execution results.

11. The method of claim 7, wherein the parameters include at least one of an ID of the Web server, a callback address (CallbackURL), a requested local resource function, and signature information.

12. A method for cooperatively operating a Web browser and a local resource in a mobile terminal, the method comprising:
requesting, at the mobile terminal, a Web server for a particular service and receiving a Web page requesting a local resource;
delivering, at the Web browser, the Web page to a gateway server and allowing the gateway server to parse and verity parameters of the Web page;
controlling the local resource based on content of the parsed and verified parameters;
setting local resource control result as a response parameter and delivering the set response parameter to the Web browser; and
transmitting, at the Web browser a result page including the response parameter to the Web server.

13. The method of claim 12, wherein said allowing the gateway server to parse and verity parameters of the Web page includes checking a signature field value contained in the parameters to verify content of the parameters.

14. The method of claim 12, wherein said receiving a Web page provides, at the Web server, a desired service using a hypertext transfer protocol (HTTP) channel or a hypertext transfer protocol over secure socket layer (HTTPS) channel.

15. The method of claim 12, wherein the local resource includes an application and a data file.
